(19) United States
(12) Patent Application Publication
(10) Pub. No.: US 2017/0078240 A1
(43) Pub. Date: Mar. 16, 2017

(54) TECHNIQUES TO SELECT AND CONFIGURE MEDIA FOR MEDIA MESSAGING

(71) Applicant: WhatsApp Inc., Mountain View, CA (US)

(72) Inventors: Randall Sarafa, San Francisco, CA (US); Kuan Loong Yong, San Francisco, CA (US); Jan Koum, Santa Clara, CA (US); Anton Borzov, London (GB)

(73) Assignee: WHATSAPP INC., Mountain View, CA (US)

(21) Appl. No.: 14/855,444

(22) Filed: Sep. 16, 2015

(51) Int. Cl. H04L 12/58; H04W 4/12; H04N 5/232

(52) U.S. Cl. CPC H04L 51/32; H04N 5/23293; H04W 4/12

(57) ABSTRACT

Techniques to select and configure media for media messaging using an adaptive selection interface are described. In one embodiment, for example, an apparatus may comprise a user interface component operative to receive a control activation for an image inclusion control; instantiate a hybrid image inclusion interface, the hybrid image inclusion interface comprising at least an image capture interface portion and an image repository interface portion; receive an interface activation for one of the image capture interface portion and the image repository interface portion; transition the image capture interface portion to a full-screen image capture interface where the interface activation is for the image capture interface portion; and transition the image repository interface portion to an expanded image repository interface where the interface activation is for the image repository interface portion. Other embodiments are described and claimed.

### BACKGROUND

Users may interact with each other in a messaging system, sending messages back and forth to each other in a text-based conversation between two or more users. A user may have a user account associated with them in the messaging system, the user account providing an online identity for the user, a destination for messages directed to the user, and generally coordinating the user's access to and use of the messaging system. A user may access the messaging system from a variety of endpoints, including mobile devices (e.g., cellphones), desktop computers, web browsers, specialized messaging applications, etc.

### SUMMARY

The following presents a simplified summary in order to provide a basic understanding of some novel embodiments described herein. This summary is not an extensive overview, and it is not intended to identify key/critical elements or to delineate the scope thereof. Some concepts are presented in a simplified form as a prelude to the more detailed description that is presented later.

Various embodiments are generally directed to techniques to select and configure media for media messaging using an adaptive selection interface. In one embodiment, for example, an apparatus may comprise a user interface component operative to receive a control activation for an image inclusion control; instantiate a hybrid image inclusion interface, the hybrid image inclusion interface comprising at least an image capture interface portion and an image repository interface portion, the image capture interface portion displaying a live capture preview for an image capture device, the image repository interface portion comprising at least a display of a camera roll; receive an interface activation for one of the image capture interface portion and the image repository interface portion; transition the image capture interface portion to a full-screen image capture interface where the interface activation is for the image capture interface portion; and transition the image repository interface portion to an expanded image repository interface where the interface activation is for the image repository interface portion. Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of a media acquisition system.

FIG. 2A illustrates an embodiment of a user interface displaying a messaging interface.

FIG. 2B illustrates an embodiment of a user interface displaying a hybrid image inclusion interface.

FIG. 2C illustrates an embodiment of a user interface displaying a full-screen image capture interface.

FIG. 2D illustrates an embodiment of a user interface displaying an expanded image repository interface.

FIG. 3 illustrates an embodiment of a messaging client determining a selected image for messaging.

FIG. 4 illustrates an embodiment of a logic flow for the system of FIG. 1.

FIG. 5 illustrates an embodiment of a centralized system for the system of FIG. 1.

FIG. 6 illustrates an embodiment of a distributed system for the system of FIG. 1.

FIG. 7 illustrates an embodiment of a computing architecture.

FIG. 8 illustrates an embodiment of a communications architecture.

FIG. 9 illustrates an embodiment of a radio device architecture.

### DETAILED DESCRIPTION

The sending of images, particularly photographs, between users may be a beneficial use of a messaging system, expanding the users' communication from a text-only exchange to a more vibrant, multimedia interaction. In some instances, users may send photographs that they've previously taken, that are stored on a camera roll on their device or that may be stored in an online photo repository. In other instances, users may send photographs that they take during the composition of the message.

In one version of a message composition interface, users composing a message may be shown distinct controls: one control for including an image from their camera roll and another control for capturing a photo for inclusion. However, this technique may increase the screen space used for the display of photo or image inclusion controls, making the message composition interface less efficient or preventing the inclusion of other controls that a user may desire, such as for songs, smilies, emoji, stickers, or other items for messaging.

In another version of a message composition interface, users composing a message may be shown a unified control, a single control to initiate a process of including either already-captured photos or capturing a photo for inclusion, with this unified control instantiating a user interface querying the user as to whether they want to see already-captured photos or a capture interface. However, this technique imposes on the user the operation of two interface controls—the unified control and then an action selection control—to view already-captured photos or to view an image capture interface.

As such, users may benefit from being offered a single photo inclusion control in a message composition interface, with this single photo inclusion control instantiating a hybrid photo interface offering the benefits of both selecting from a camera roll and capturing using a camera device in a unified, combined interface. This may provide the efficiency in the message composition interface of offering only a single photo inclusion control. This may also provide the efficiency in user interface manipulation of only entailing a single interface operation to move from a message composition interface to either of selecting a photo from a camera roll and capturing a photo with a camera device. As a result, the embodiments can improve the efficiency and convenience of including photo content—or any image content—in a media message.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

It is worthy to note that “a” and “b” and “c” and similar designators as used herein are intended to be variables representing any positive integer. Thus, for example, if an implementation sets a value for a=5, then a complete set of components 122 illustrated as components 122-1 through 122-a may include components 122-1, 122-2, 122-3, 122-4 and 122-5. The embodiments are not limited in this context.

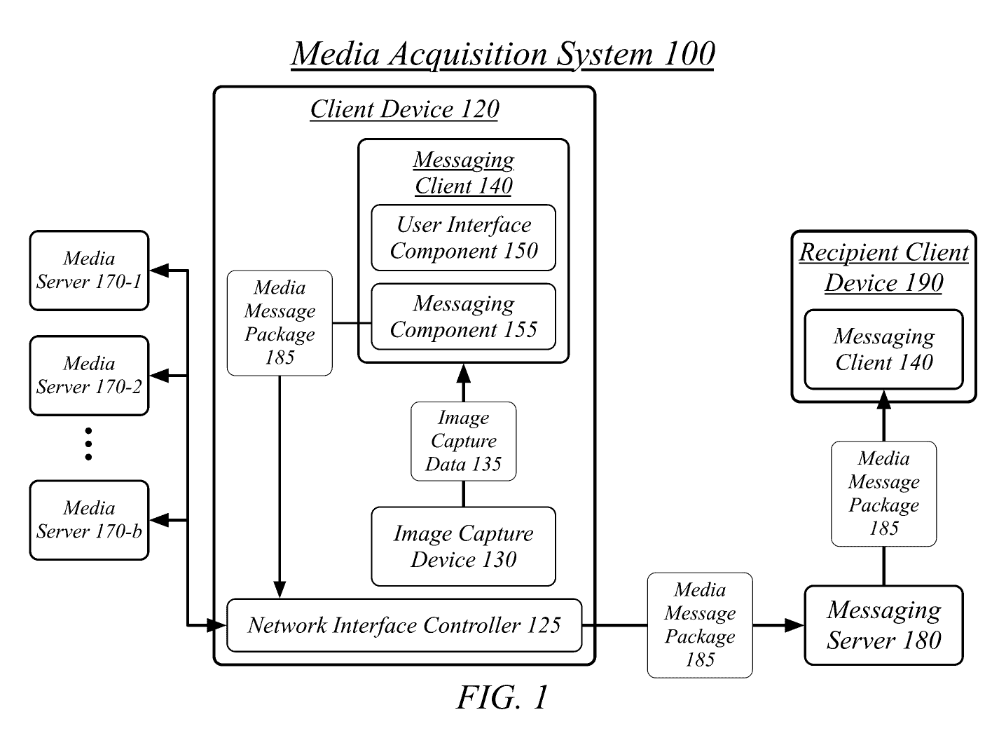

FIG. 1 illustrates a block diagram for a media acquisition system 100. In one embodiment, the media acquisition system 100 may comprise a computer-implemented system having software applications comprising one or more components. Although the media acquisition system 100 shown in FIG. 1 has a limited number of elements in a certain topology, it may be appreciated that the media acquisition system 100 may include more or less elements in alternate topologies as desired for a given implementation.

A user's access to a media acquisition system 100 may be a messaging client 140 installed as a user application on a client device 120 and executing locally on the client device 120. In some cases, the messaging client 140 may include other functionality. For example, the messaging client 140 may be a front-end to a social-networking service, providing messaging services in association with the social-networking service. In many cases, this client device 120 may be a smartphone, cell phone, or other mobile device using a mix of Wi-Fi and cellular data networks to access the Internet and networked resources, though it will be appreciated that any form of network access may be used. For example, one device may tether to another, such as a smart watch tethering to a Internet-capable device (e.g., mobile phone, personal computer) or a mobile phone tethering to a personal computer. The client device 120 may execute a plurality of applications, including the messaging client 140. In other embodiments, however, the client device 120 may comprise a personal computer device, a portable digital assistant, a tablet device, or any other form of computing device. Similarly, in some situations and embodiments, a user may access the media acquisition system 100 via a web portal, with the messaging client 140 executing as a web-based application.

The client device 120 may communicate with other devices using wireless transmissions to exchange network traffic. Exchanging network traffic, such as may be included in the exchange of messaging transactions, may comprise transmitting and receiving network traffic via a network interface controller 125 (NIC). A NIC comprises a hardware component connecting a computer device, such as client device 120, to a computer network. The NIC may be associated with a software network interface empowering software applications to access and use the NIC. Network traffic may be received over the computer network as signals transmitted over data links. The network traffic may be received by capturing these signals and interpreting them. The NIC may receive network traffic over the computer network and transfer the network traffic to memory storage accessible to software applications using a network interface application programming interface (API). The network interface controller 135 may be used for the network activities of the embodiments described herein, including the interoperation of the media servers 170, messaging client 140, and messaging server 180 through network communication. For example, the messaging client 140 transmitting a media message package 185 to a messaging server 180 may be interpreted as using the network interface controller 125 for network access to a communications network for the transmission of the media message package 185.

The client device 120 may include an image capture device 130. The image capture device 130 may comprise a camera operative to capture one or both of still images and moving images (i.e., video). The image capture device 130 may provide image capture data 135 to the messaging client 130, the image capture data 135 comprise one or more of image content, video content, audio content (e.g., for video), image capture context information, and any other image-capture related data. The messaging client 140 may be empowered by the client device 120, such as by an operating system of the client device 120, to access the image capture device 130—as may be mediated by operating system application programming interfaces (APIs)—and capture image content.

The media servers 170 may provide functionality for one or more of searching media content, discovering media content, sharing media content, storing media content, accessing media content, modifying media content, and combining media content. Each of the media servers 170 may be associated one or more media services. Each of a plurality of media services may provide one or more media servers 170 for storing, retrieving, and generally exchanging media content. One or more of the media servers 170 may host an image repository for the user of the messaging client 140 and client device 120. An image repository may collect images for the user, such as an online photo repository.

The messaging client 140 may comprise a user interface component 150. The user interface component 150 may be generally arranged to provide interfaces to the functionality of the messaging client 140. For instance, the user interface component 150 may provide interfaces to image capture, image retrieval, and other image or media functions. The user interface component 150 may provide interfaces to message viewing, message composition, message sending, and other messaging functions. In general, the user interface component 150 may provide interfaces for any functionality of the messaging client 140.

Determining the selection of a control, area, or other element of a user interface may comprise receiving an interrupt, API call, signal, or other indication from an interface library and/or operating system of the client device 120. The user interface component 150 may be operative to receive user interface interactions from the operating system and to translate these user interface interactions into the activation of various user interface elements. In some embodiments, various user interface elements may be registered with an interface library and/or operating system, with the interface library and/or operating system providing user interface interactions in reference to particular user interface elements.

The messaging client 140 may comprise a messaging component 155. The messaging component 155 may be generally arranged to provide messaging services to a user of the client device 120. Messaging services may comprise the reception of messages, the sending of messages, the maintenance of a history of messages exchanged, and other messaging-related activities. User of the messaging client 140 may be empowered to engage in messaging conversations with a plurality of other users in both private user-to-user conversations, in private group conversations between three or more users, and in public conversations generally open to the messaging community. The messaging component 155 may interoperate with the media management component 160 to enrich any of these messaging conversations with the media content management by the media management component 160.

The media acquisition system 100 may include a messaging server 180 from among a plurality of messaging servers. The messaging server 180 may operate as an intermediary between the messaging endpoints of users of the media acquisition system 100. The messaging server 180 may track the current network address of a user's active messaging endpoint or endpoints, such as they change network (e.g., a mobile client device 120 moving between Wi-Fi networks, between cellular data networks, and between Wi-Fi and cellular data networks). The messaging server 180 may queue messages for messaging endpoints when they are offline or otherwise not accepting new messages. The messaging server 180 may provide an ordering on messages for a particular user so as to provide consistency in the flow of communication between the potentially multiple messaging endpoints that a user might use. The messaging server 180 may store a messaging history for each user so as to provide access to previously-sent or received messages for a user. The messaging history may include media exchanged between users using the media acquisition system 100.

The messaging component 155 may transmit a media message package 185 to a messaging server 180 for delivery to one or more other users of the media acquisition system 100. The media message package 185 may comprise delivery information, such as one or more delivery user identifiers identifying one or more users for the media message package 185. The media message package 185 may comprise a rich message incorporating a media element and, potentially, a text message component. It will be appreciated that in some cases text messages may be sent without associated media elements through the messaging server 180. The messaging server 180 may receive the media message package 185 and deliver it to a messaging endpoint—such as an installation of the messaging client 140 on a recipient client device 190—associated with a delivery user account identified by a delivery user identifier for the media message package 185.

The media acquisition system 100 may use knowledge generated from interactions in between users. The media acquisition system 100 may comprise a component of a social-networking service and may use knowledge generated from the broader interactions of the social-networking service. As such, to protect the privacy of the users of the media acquisition system 100 and the larger social-networking service, media acquisition system 100 may include an authorization server (or other suitable component(s)) that allows users to opt in to or opt out of having their actions logged by the media acquisition system 100 or shared with other systems (e.g., third-party systems), for example, by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers or other authorization components may be used to enforce one or more privacy settings of the users of the media acquisition system 100 and other elements of a social-networking service through blocking, data hashing, anonymization, or other suitable techniques as appropriate. For example, while interactions between users of a social-networking service and the social-networking service may be used to learn media content preferences and the relationship between preferences for different pieces of media content, these interactions may be anonymized prior to or as part of the learning process.

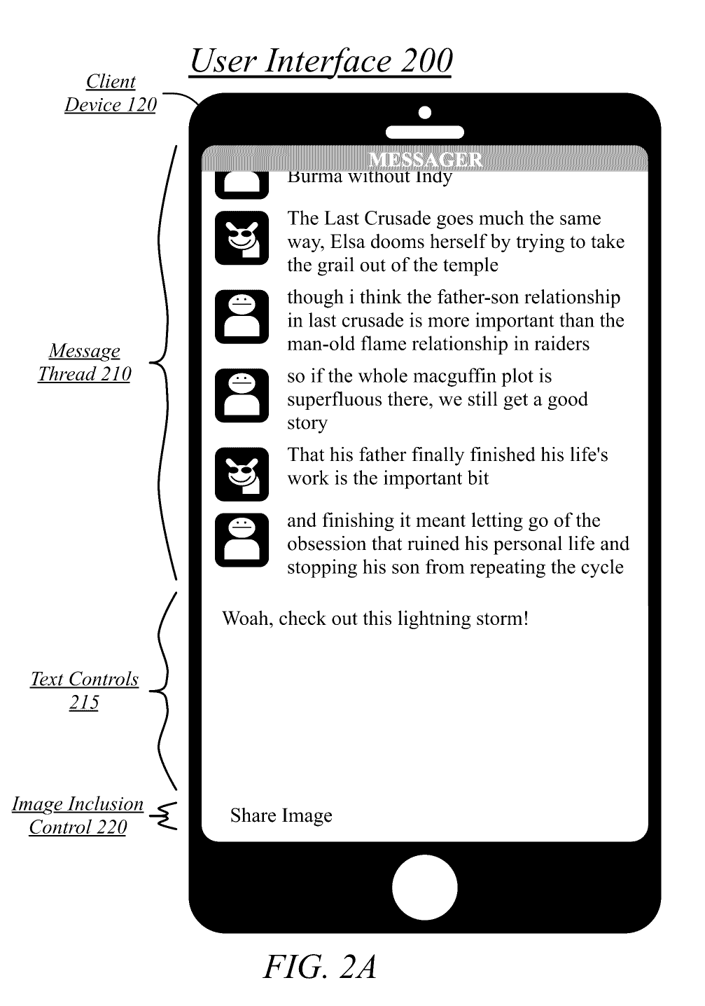

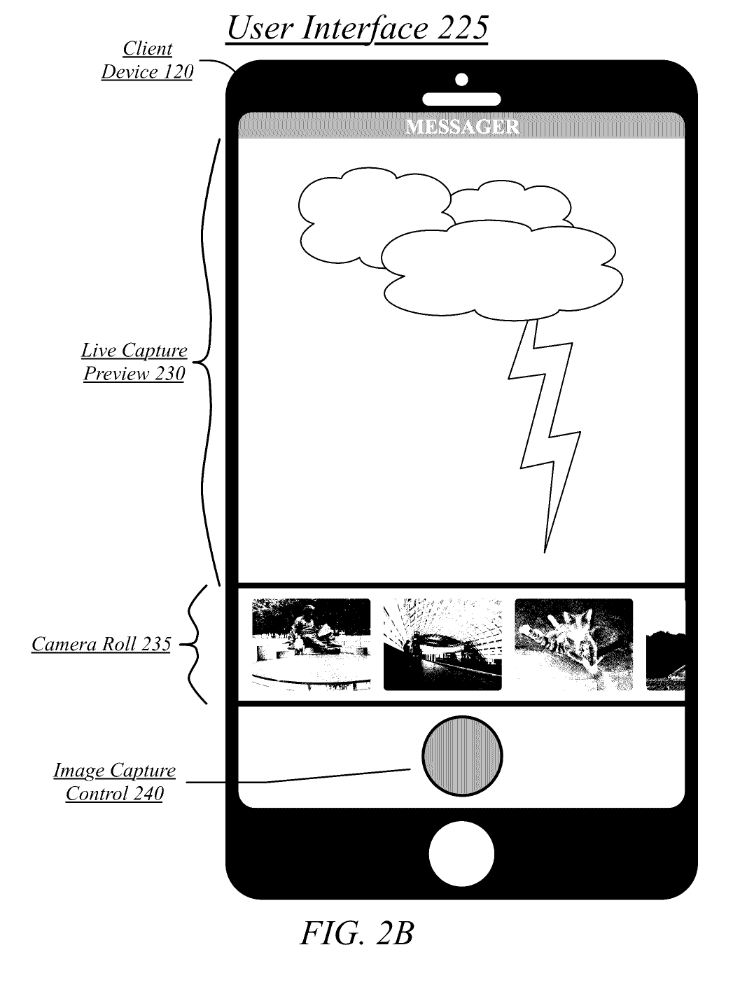

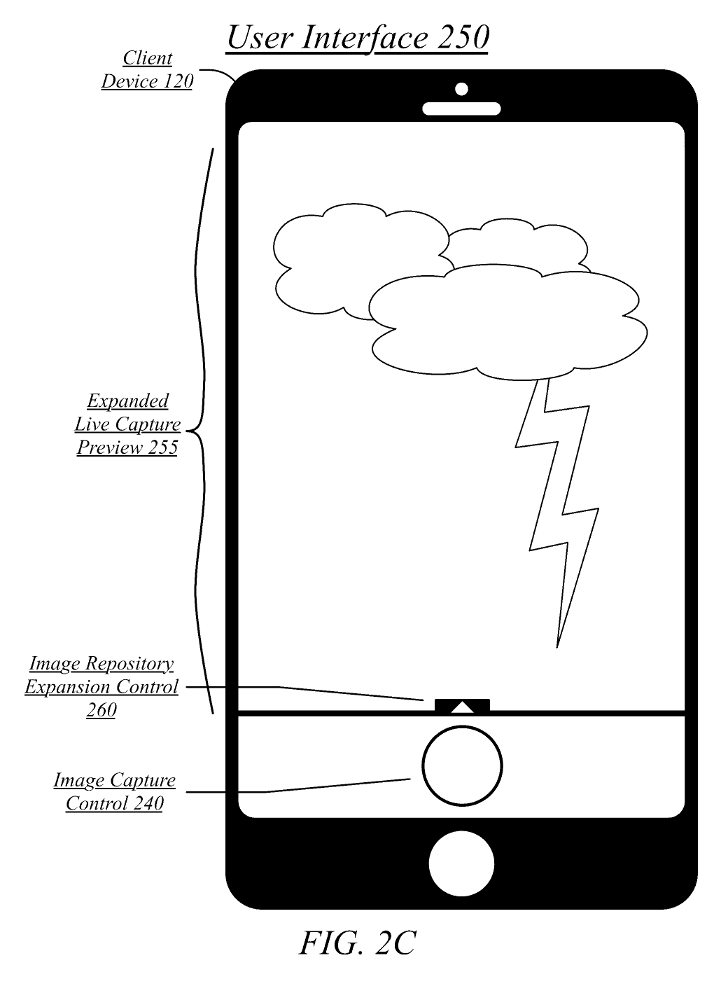

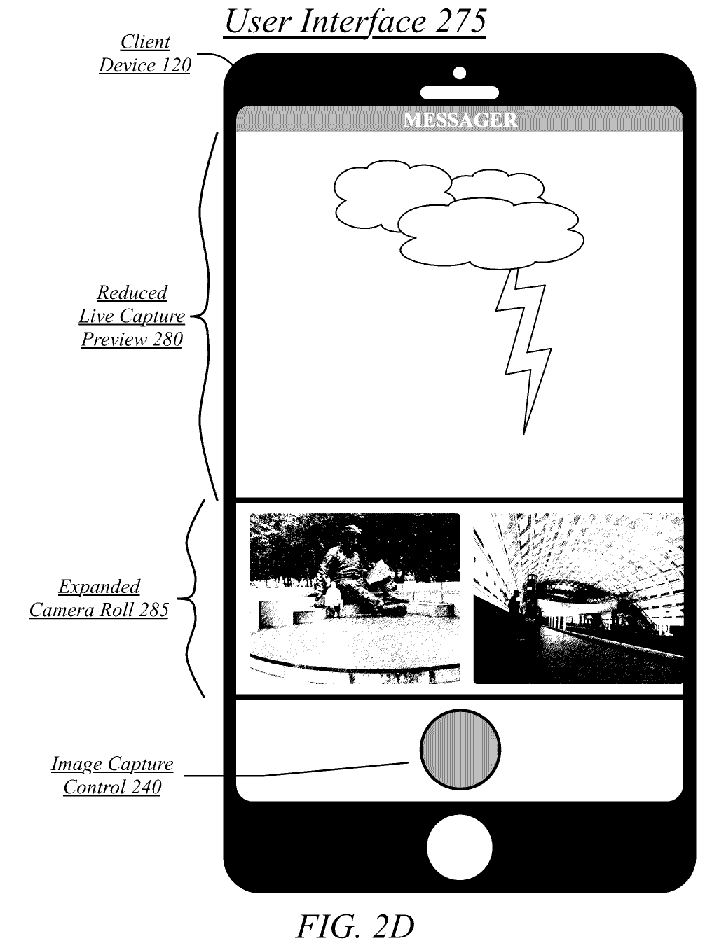

FIG. 2A illustrates an embodiment of a user interface 200 displaying a messaging interface.

In the illustrated embodiment of FIG. 2A, the messaging client 140 is displaying a message thread 210. The illustrated message thread 210 corresponds to a private messaging conversation between two users. The user of client device 120 and the messaging client 140 may use text controls 215 to enter textual elements of the message thread 210, such as text messages for transmission to the second user on the recipient client device 190. It will be appreciated that while the text controls 215 and other controls of the messaging client 140 are depicted as touch-controls on a touch screen that other controls, including a hardware keyboard and hardware pointer control, may be used with other embodiments.

The user interface 200 may include an image inclusion control 220. It will be appreciated that additional and alternative sharing controls may be included in various embodiments, such as one or more sharing controls for one or more of animated images, video, and audio. For example, while in the illustrated embodiment a sharing control is specific to a particular content type (i.e., images) that in other embodiments different divisions may be used or that no division may be used. In some cases, a universal share control may be provided to users providing access to all types of media content. In some cases, sharing controls may be provided for specific forms of content, such as stickers, songs, smilies, emoji, GIFs, and other categories of media content.

The user of the messaging client 140 may select the image inclusion control 220 to initiate the selection of image content for sharing in the message thread 210 with the second user. In some embodiments, the image inclusion control 220 may be displayed without the adjacent text controls 215. In some embodiments, a variety of controls may be displayed along the bottom of the user interface 200 for the messaging client 140, with one of the variety of controls invoking the text controls 215 and others one or more of various varieties of sharing controls dedicated to different types of media content. The selection of the image inclusion control 220 may initiate the instantiation of a hybrid image inclusion interface.

FIG. 2B illustrates an embodiment of a user interface 225 displaying a hybrid image inclusion interface on a client device 120.

The example hybrid image inclusion interface may have been reached via the selection of an image inclusion control, such as described with reference to FIG. 2A. A hybrid image inclusion interface may include both an image capture interface portion and an image repository interface portion, the hybrid image inclusion interface therefore empowering the immediate initiation of either image capture or selection of an image from an image repository.

The image capture interface portion may include at least a live capture preview 230 displaying a live stream of the image stream being captured by the image capture device 130, the live capture preview 230 serving as a preview of what will be captured if image capture is initiated. The initiation of the hybrid image inclusion interface may therefore prompt the activation of the image capture device 130 by the messaging client 140. The image capture interface portion may also include an image capture control 240, the image capture control 240 operate to initiate image capture, whether still image or video. In some embodiments, the image capture control 240 may empower the activation of either still image or video capture depending on the manner in which it is activated by the user. For instance, a press on the image capture control 240 may initiate still image capture while holding the image capture control 240 may initiate video capture. Initiating image capture may transition the image capture interface portion to a full-screen image capture interface.

The image repository interface portion may include a display of a camera roll 235 for the user. The camera roll 235 may comprise a collection of photographs associated with the user. In some cases, the camera roll 235 may comprise a local camera roll stored locally on the client device 120 and comprising specifically or exclusively photos captured by the client device 120. In some cases, the camera roll 235 may comprise an online camera roll primarily stored on a server device, such as in a cloud service, which may also be cached on the client device 120. This camera roll 235 may still be specifically or exclusively photos captured by the client device 120, or may comprise a cross-device camera roll collecting together photos captured by a plurality of devices.

Selecting a displayed photo in the camera roll 235 may select the photo for inclusion in a message being composed in the messaging client 140. Selection of the display area of the camera roll 235 without selecting a particular photo may result in an expansion of the image repository interface portion to an expanded image repository interface and/or full-screen image repository interface. Selection of the display area of the camera roll 235 without selecting a particular photo may correspond to a selection of a border of the display area of the camera roll 235, particularly as may be applied by a user in an expanding gesture. Selection of the display area of the camera roll 235 without selecting a particular photo may correspond to an expanding gesture over any portion of the display area of the camera roll 235.

FIG. 2C illustrates an embodiment of a user interface 250 displaying a full-screen image capture interface.

A full-screen image capture interface may comprise an expanded live capture preview 255, the expanded live capture preview 255 replacing the image repository interface portion displaying the camera roll 235. The expanded live capture preview 255 may be substantially similar to the live capture preview 230 described with reference to FIG. 2B but expanded to fill more of the screen of the client device 120 in comparison to amount of the screen filled by the live capture preview 230. The display of the image capture control 240 may remain unchanged so as to provide continuity in any activation of the image capture control 240 by the user of the client device 120. The full-screen image capture interface may comprise an image repository expansion control 260, the image repository expansion control 260 empowering the user to recall the image repository interface portion, thereby transitioning the full-screen image capture interface to the hybrid image inclusion interface.

FIG. 2D illustrates an embodiment of a user interface 275 displaying an expanded image repository interface.

An expanded image repository interface may comprise a user interface in which a larger portion of the display of the client device 120 is given over to an expanded camera roll 285 than was given to the prior display of the camera roll 235, corresponding to an expanded version of the camera roll 235 described with reference to FIG. 2B. An expanded camera roll 285 may comprise at least one of an expansion of the size of the displayed photos and/or an expansion of the number of displayed photos. The expanded image repository interface may occupy at least a portion of the screen previously dedicated to the live capture preview 230 in the initial hybrid image inclusion interface.

In some embodiments, an expanded image repository interface may comprise a full-screen image repository interface. A full-screen image repository interface may comprise a particular case of or an alternative to the expanded image repository interface in which the reduced live capture preview 280 is excluded and the expanded camera roll 285 replaces the entire area previously devoted to the live capture preview 230 and/or the image capture control 240. The full-screen image repository interface may comprise an image capture expansion control, the image capture expansion control empowering the user to recall the image capture interface portion, thereby transitioning the full-screen image repository interface to the hybrid image inclusion interface.

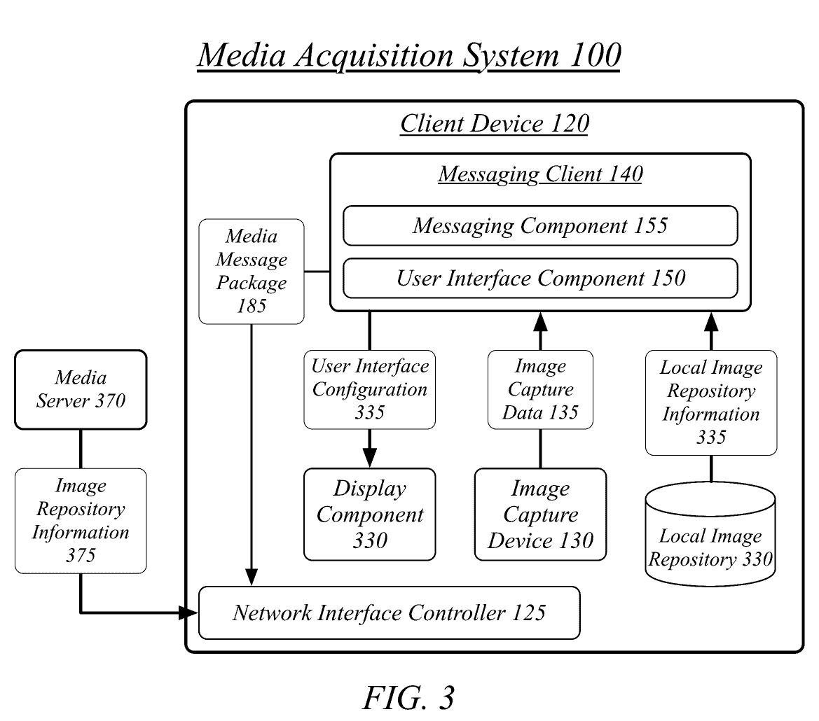

FIG. 3 illustrates an embodiment of a messaging client determining a selected image for messaging.

The user interface component 150 may be operative to receive a control activation for an image inclusion control on the client device 120. In some embodiments, the image inclusion control may be received in a message composition interface for a messaging client 140 on the client device 120. The user interface component 150 may be operative to receive an image from one of a full-screen image capture interface or an expanded image repository interface. The messaging component 155 may be operative to generate an outgoing message, the outgoing message comprising the image, and transmit the outgoing message to a messaging service via a network interface controller 125 communicatively connected to a network. Transmitting the outgoing message to a messaging service may comprise transmitting a media message package 185 to a message server 180 for the messaging service.

The user interface component 150 may be operative to instantiate a hybrid image inclusion interface, the hybrid image inclusion interface comprising at least an image capture interface portion and an image repository interface portion. The image capture interface portion may display a live capture preview for the image capture device 130. Instantiating an interface, such as the hybrid image inclusion interface or any other inference, may comprise transmitting a user interface configuration 335 to a display component 330, as may be mediated by one or more libraries and/or operating system components.

The image capture interface portion may comprise at least an image capture control and a live capture preview. As such, the interface activation for the image capture interface portion may comprise an image capture control activation for the image capture control. The user interface component 150 may be operative to initiate a still image capture in response to the image capture control activation for the image capture control comprising a press of the image capture control. The user interface component 150 may be operative to initiate a video image capture in response to the image capture control activation for the image capture control comprising a hold of the image capture control. The user interface component 150 may be operative to cancel a video image capture in response to an image capture control deactivation for the image capture control, wherein the image capture control deactivation corresponds to a screen-drag-off gesture on a touchscreen display for the client device. The user interface component 150 may be operative to automatically upload a captured image to an image repository for a network image repository service. Where a captured image is automatically uploaded, the automatic upload may be contingent upon a user registering the network image repository service for automatic uploading.

The image repository interface portion may comprise at least a display of a camera roll for the client device 120. Displaying a camera roll for the client device 120 may include retrieving local image repository information 345 from a local image repository 340 on the client device 120. The local image repository 340 may store a collection of local photographs, with the local image repository information 345 comprising the local photographs and/or information relating to the local photographs. Alternatively or additionally, the image repository interface portion may comprise at least a display of an image repository for a network image repository service. The user interface component 150 may retrieve one or more images of the image repository from the network image repository service via a network interface controller 125 communicatively connected to a network and display the one or more images in the image repository interface portion as the display of the image repository. Retrieving one or more images of an image repository may comprise retrieving image repository information 375 from a media server 370, the media server 370 comprising en element of the network image repository service. In some embodiments, the image repository interface portion may combine images from a local camera roll on the client device 120 with images from the image repository for the network image repository service.

In some embodiments, the image repository interface portion may comprise at least a display of a plurality of image repositories for a plurality of network image repository services. The user interface component 150 may retrieve a plurality of images of the plurality of image repositories from the plurality of network image repository services via a network interface controller 125 communicatively connected to a network, generate a de-duplicated plurality of images from the received plurality of images, wherein the de-duplicated plurality of images excludes duplicated instances of duplicated images in the received plurality of images, and display the de-duplicated plurality of images in the image repository interface portion as the display of the plurality of image repositories. Generating the de-duplicated plurality of images from the received plurality of images may comprise selecting one or more higher-quality versions of the duplicated instances of the duplicated images.

The user interface component 150 may be operative to receive an interface activation for one of the image capture interface portion and the image repository interface portion. The user interface component 150 may be operative to transition the image capture interface portion to a full-screen image capture interface where the interface activation is for the image capture interface portion. The full-screen image capture interface may comprise an image repository expansion control for the image repository interface portion. The user interface component 150 may be operative to transition the image repository interface portion to an expanded image repository interface where the interface activation is for the image repository interface portion. The expanded image repository interface may comprise an image capture expansion control for the image capture interface portion.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

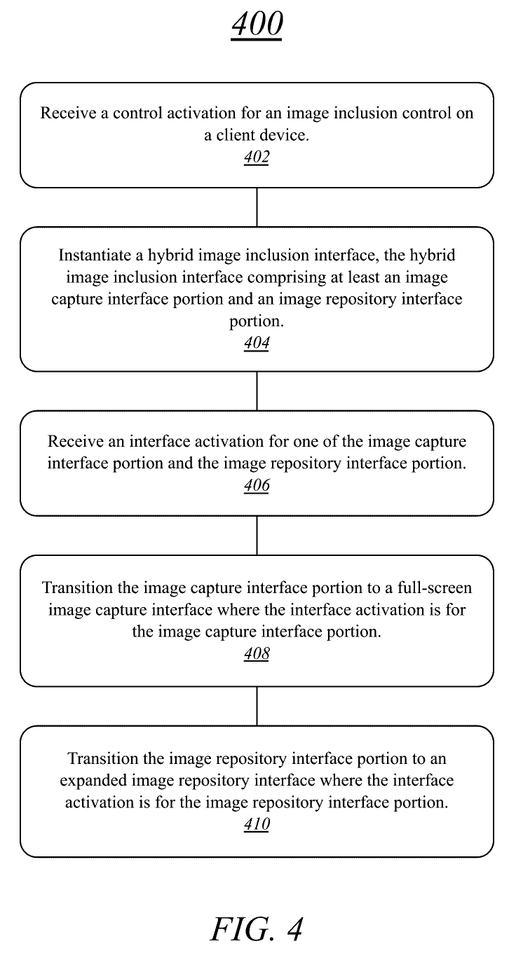

FIG. 4 illustrates one embodiment of a logic flow 400. The logic flow 400 may be representative of some or all of the operations executed by one or more embodiments described herein.

In the illustrated embodiment shown in FIG. 4, the logic flow 400 may receive a control activation for an image inclusion control on a client device at block 402.

The logic flow 400 may instantiate a hybrid image inclusion interface, the hybrid image inclusion interface comprising at least an image capture interface portion and an image repository interface portion at block 404.

The logic flow 400 may receive an interface activation for one of the image capture interface portion and the image repository interface portion at block 406.

The logic flow 400 may transition the image capture interface portion to a full-screen image capture interface where the interface activation is for the image capture interface portion at block 408.

The logic flow 400 may transition the image repository interface portion to an expanded image repository interface where the interface activation is for the image repository interface portion at block 410.

The embodiments are not limited to this example.

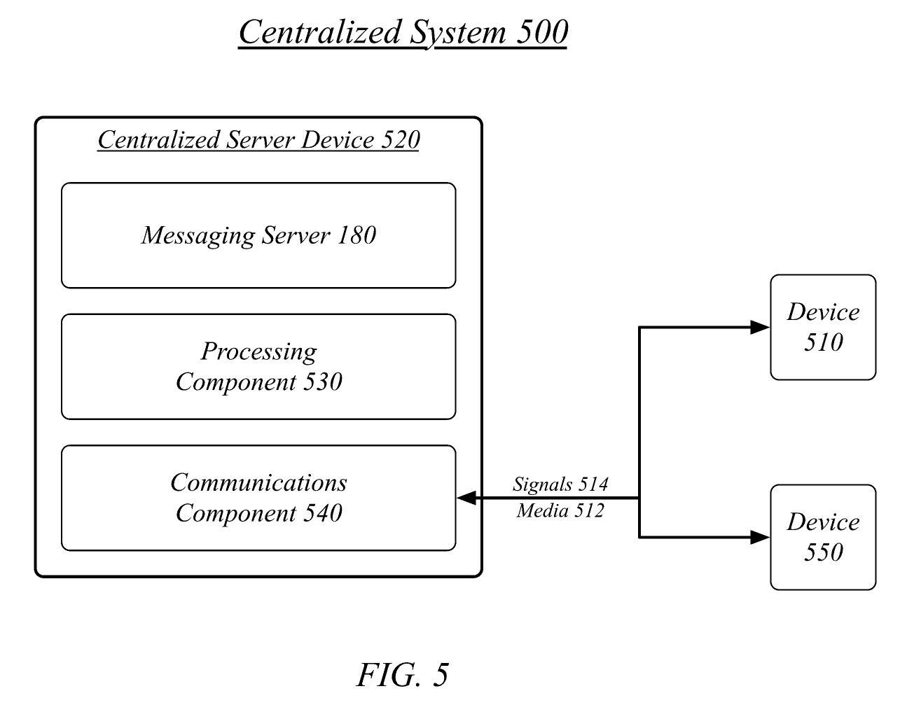

FIG. 5 illustrates a block diagram of a centralized system 500. The centralized system 500 may implement some or all of the structure and/or operations for the media acquisition system 100 in a single computing entity, such as entirely within a single centralized server device 520.

The centralized server device 520 may comprise any electronic device capable of receiving, processing, and sending information for the media acquisition system 100. Examples of an electronic device may include without limitation an ultra-mobile device, a mobile device, a personal digital assistant (PDA), a mobile computing device, a smart phone, a telephone, a digital telephone, a cellular telephone, ebook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, subscriber station, mobile subscriber center, radio network controller, router, hub, gateway, bridge, switch, machine, or combination thereof. The embodiments are not limited in this context.

The centralized server device 520 may execute processing operations or logic for the media acquisition system 100 using a processing component 530. The processing component 530 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The centralized server device 520 may execute communications operations or logic for the media acquisition system 100 using communications component 540. The communications component 540 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 540 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 512 includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

The centralized server device 520 may communicate with other devices 510, 550 over a communications media 512 using communications signals 514 via the communications component 540. The devices 510, 550 may be internal or external to the centralized server device 520 as desired for a given implementation.

The centralized system 500 may correspond to an embodiment in which a single messaging server 180 is used executing on a single messaging server device 520. The devices 510, 550 may correspond to client devices—such as client device 120 and recipient client device 190—using the messaging server 180 for messaging services.

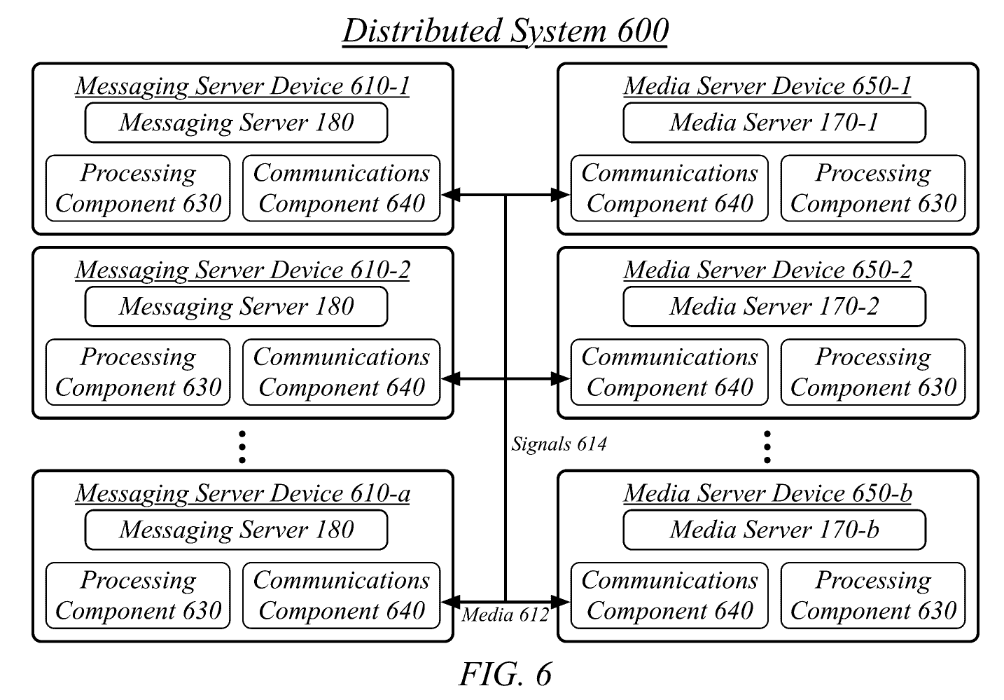

FIG. 6 illustrates a block diagram of a distributed system 600. The distributed system 600 may distribute portions of the structure and/or operations for the media acquisition system 100 across multiple computing entities. Examples of distributed system 600 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

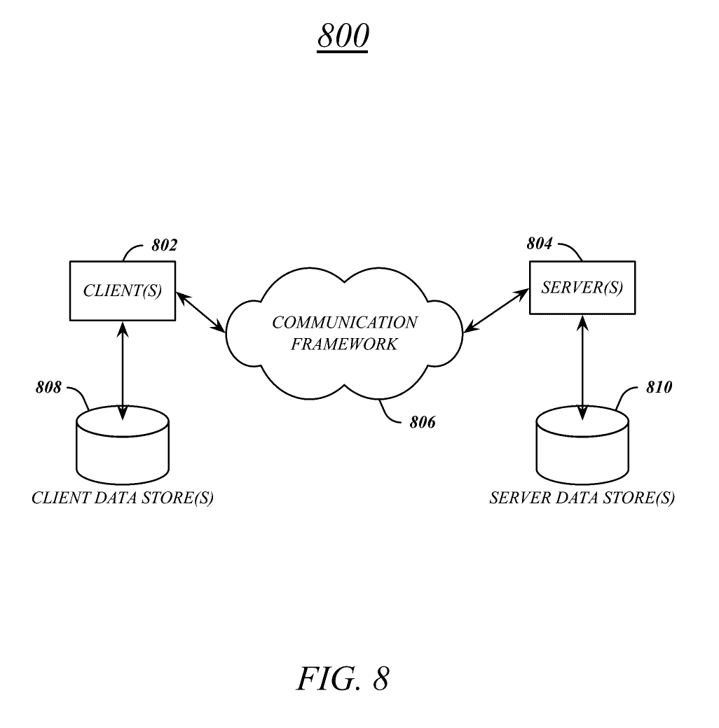

The distributed system 600 may comprise a first server device 610 and a second server device 650. In general, the server devices 610, 650 may be the same or similar to the centralized server device 520 as described with reference to FIG. 5. For instance, the server devices 610, 650 may each comprise a processing component 630 and a communications component 640 which are the same or similar to the processing component 830 and the communications component 840, respectively, as described with reference to FIG. 8. In another example, the server devices 610, 650 may communicate over a communications media 612 using communications signals 614 via the communications components 640.

The plurality of messaging server devices 610 may comprise or employ one or more client programs that operate to perform various methodologies in accordance with the described embodiments. In one embodiment, for example, the plurality of messaging server devices 610 may collectively implement the messaging server 180 as a distributed messaging server 180. Each of the messaging server devices 610 may execute a messaging server 180 to collectively provide messaging services to the users of the media messaging system 100.

The plurality of media server devices 650 may comprise or employ one or more server programs that operate to perform various methodologies in accordance with the described embodiments. In one embodiment, for example, the plurality of media server devices 650 may implement the media servers 170.

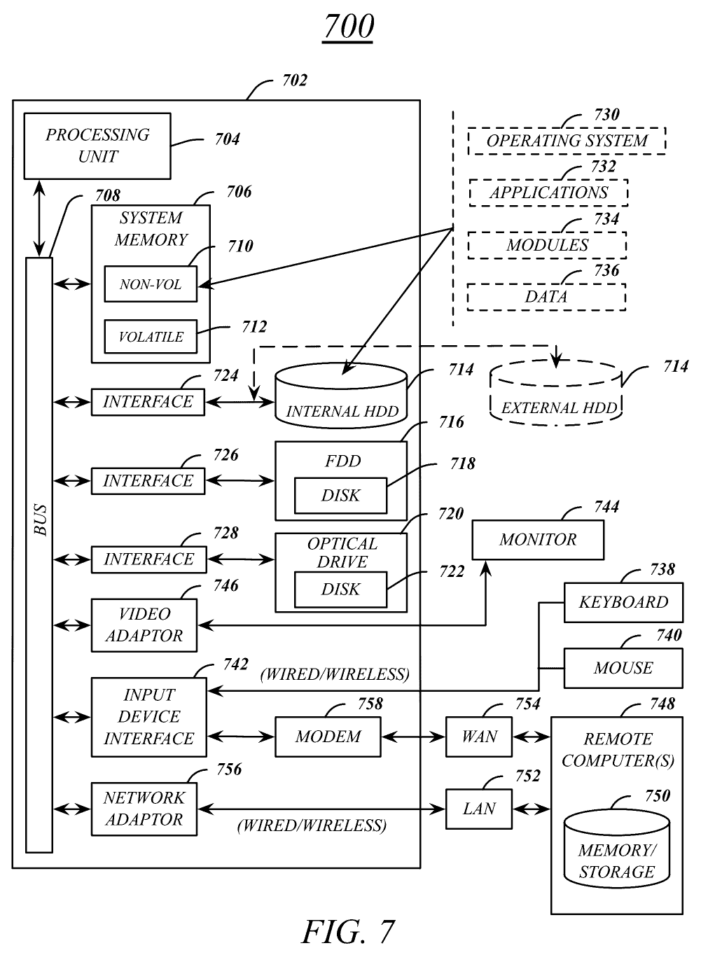

FIG. 7 illustrates an embodiment of an exemplary computing architecture 700 suitable for implementing various embodiments as previously described. In one embodiment, the computing architecture 700 may comprise or be implemented as part of an electronic device. Examples of an electronic device may include those described with reference to FIG. 5 and FIG. 6, among others. The embodiments are not limited in this context.

As used in this application, the terms “system” and “component” are intended to refer to a computer-related entity, either hardware, a combination of hardware and software, software, or software in execution, examples of which are provided by the exemplary computing architecture 700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 700 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 700.

As shown in FIG. 7, the computing architecture 700 comprises a processing unit 704, a system memory 706 and a system bus 708. The processing unit 704 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 704.

The system bus 708 provides an interface for system components including, but not limited to, the system memory 706 to the processing unit 704. The system bus 708 can be any of several types of bus structure that may further interconnect to a memory bus (with or without a memory controller), a peripheral bus, and a local bus using any of a variety of commercially available bus architectures. Interface adapters may connect to the system bus 708 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 700 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 706 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 7, the system memory 706 can include non-volatile memory 710 and/or volatile memory 712. A basic input/output system (BIOS) can be stored in the non-volatile memory 710.

The computer 702 may include various types of computer-readable storage media in the form of one or more lower speed memory units, including an internal (or external) hard disk drive (HDD) 714, a magnetic floppy disk drive (FDD) 716 to read from or write to a removable magnetic disk 718, and an optical disk drive 720 to read from or write to a removable optical disk 722 (e.g., a CD-ROM or DVD). The HDD 714, FDD 716 and optical disk drive 720 can be connected to the system bus 708 by a HDD interface 724, an FDD interface 726 and an optical drive interface 728, respectively. The HDD interface 724 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 710, 712, including an operating system 730, one or more application programs 732, other program modules 734, and program data 736. In one embodiment, the one or more application programs 732, other program modules 734, and program data 736 can include, for example, the various applications and/or components of the media acquisition system 100.

A user can enter commands and information into the computer 702 through one or more wire/wireless input devices, for example, a keyboard 738 and a pointing device, such as a mouse 740. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 704 through an input device interface 742 that is coupled to the system bus 708, but can be connected by other interfaces such as a parallel port, IEEE 1394 serial port, a game port, a USB port, an IR interface, and so forth.

A monitor 744 or other type of display device is also connected to the system bus 708 via an interface, such as a video adaptor 746. The monitor 744 may be internal or external to the computer 702. In addition to the monitor 744, a computer typically includes other peripheral output devices, such as speakers, printers, and so forth.

The computer 702 may operate in a networked environment using logical connections via wire and/or wireless communications to one or more remote computers, such as a remote computer 748. The remote computer 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wire/wireless connectivity to a local area network (LAN) 752 and/or larger networks, for example, a wide area network (WAN) 754. Such LAN and WAN networking environments are commonplace in offices and companies, and facilitate enterprise-wide computer networks, such as intranets, all of which may connect to a global communications network, for example, the Internet.

When used in a LAN networking environment, the computer 702 is connected to the LAN 752 through a wire and/or wireless communication network interface or adaptor 756. The adaptor 756 can facilitate wire and/or wireless communications to the LAN 752, which may also include a wireless access point disposed thereon for communicating with the wireless functionality of the adaptor 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wire and/or wireless device, connects to the system bus 708 via the input device interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with wire and wireless devices or entities using the IEEE 802 family of standards, such as wireless devices operatively disposed in wireless communication (e.g., IEEE 802.7 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.7x (a, b, g, n, etc.) to provide secure, reliable, fast wireless connectivity. A Wi-Fi network can be used to connect computers to each other, to the Internet, and to wire networks (which use IEEE 802.3-related media and functions).

FIG. 8 illustrates a block diagram of an exemplary communications architecture 800 suitable for implementing various embodiments as previously described. The communications architecture 800 includes various common communications elements, such as a transmitter, receiver, transceiver, radio, network interface, baseband processor, antenna, amplifiers, filters, power supplies, and so forth. The embodiments, however, are not limited to implementation by the communications architecture 800.

As shown in FIG. 8, the communications architecture 800 comprises includes one or more clients 802 and servers 804. The clients 802 may implement the first server device 910. The servers 804 may implement the second server device 950. The clients 802 and the servers 804 are operatively connected to one or more respective client data stores 808 and server data stores 810 that can be employed to store information local to the respective clients 802 and servers 804, such as cookies and/or associated contextual information.

The clients 802 and the servers 804 may communicate information between each other using a communication framework 806. The communications framework 806 may implement any well-known communications techniques and protocols. The communications framework 806 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 806 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 802 and the servers 804. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

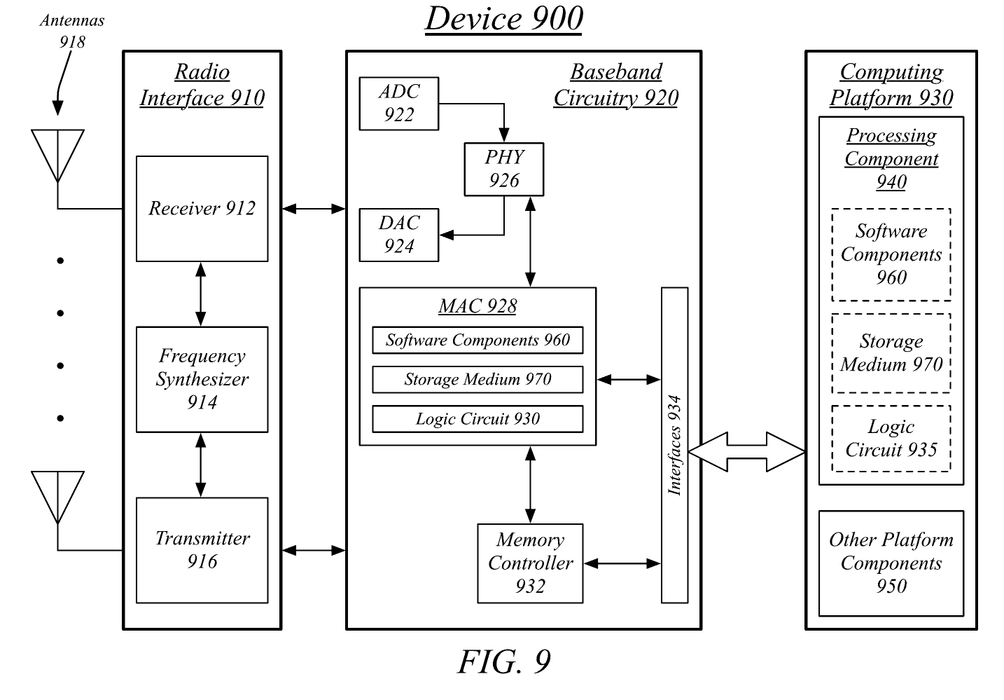

FIG. 9 illustrates an embodiment of a device 900 for use in a multicarrier OFDM system, such as the media acquisition system 100. Device 900 may implement, for example, software components 960 as described with reference to media acquisition system 100 and/or a logic circuit 935. The logic circuit 935 may include physical circuits to perform operations described for the media acquisition system 100. As shown in FIG. 9, device 900 may include a radio interface 910, baseband circuitry 920, and computing platform 930, although embodiments are not limited to this configuration.

The device 900 may implement some or all of the structure and/or operations for the media acquisition system 100 and/or logic circuit 935 in a single computing entity, such as entirely within a single device. Alternatively, the device 900 may distribute portions of the structure and/or operations for the media acquisition system 100 and/or logic circuit 935 across multiple computing entities using a distributed system architecture, such as a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In one embodiment, radio interface 910 may include a component or combination of components adapted for transmitting and/or receiving single carrier or multi-carrier modulated signals (e.g., including complementary code keying (CCK) and/or orthogonal frequency division multiplexing (OFDM) symbols) although the embodiments are not limited to any specific over-the-air interface or modulation scheme. Radio interface 910 may include, for example, a receiver 912, a transmitter 916 and/or a frequency synthesizer 914. Radio interface 910 may include bias controls, a crystal oscillator and/or one or more antennas 918. In another embodiment, radio interface 910 may use external voltage-controlled oscillators (VCOs), surface acoustic wave filters, intermediate frequency (IF) filters and/or RF filters, as desired. Due to the variety of potential RF interface designs an expansive description thereof is omitted.

Baseband circuitry 920 may communicate with radio interface 910 to process receive and/or transmit signals and may include, for example, an analog-to-digital converter 922 for down converting received signals, a digital-to-analog converter 924 for up converting signals for transmission. Further, baseband circuitry 920 may include a baseband or physical layer (PHY) processing circuit 956 for PHY link layer processing of respective receive/transmit signals. Baseband circuitry 920 may include, for example, a processing circuit 928 for medium access control (MAC)/data link layer processing. Baseband circuitry 920 may include a memory controller 932 for communicating with processing circuit 928 and/or a computing platform 930, for example, via one or more interfaces 934.

In some embodiments, PHY processing circuit 926 may include a frame construction and/or detection module, in combination with additional circuitry such as a buffer memory, to construct and/or deconstruct communication frames, such as radio frames. Alternatively or in addition, MAC processing circuit 928 may share processing for certain of these functions or perform these processes independent of PHY processing circuit 926. In some embodiments, MAC and PHY processing may be integrated into a single circuit.

The computing platform 930 may provide computing functionality for the device 900. As shown, the computing platform 930 may include a processing component 940. In addition to, or alternatively of, the baseband circuitry 920, the device 900 may execute processing operations or logic for the media acquisition system 100 and logic circuit 935 using the processing component 940. The processing component 940 (and/or PHY 926 and/or MAC 928) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing platform 930 may further include other platform components 950. Other platform components 950 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Device 900 may be, for example, an ultra-mobile device, a mobile device, a fixed device, a machine-to-machine (M2M) device, a personal digital assistant (PDA), a mobile computing device, a smart phone, a telephone, a digital telephone, a cellular telephone, user equipment, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, node B, evolved node B (eNB), subscriber station, mobile subscriber center, radio network controller, router, hub, gateway, bridge, switch, machine, or combination thereof. Accordingly, functions and/or specific configurations of device 900 described herein, may be included or omitted in various embodiments of device 900, as suitably desired. In some embodiments, device 900 may be configured to be compatible with protocols and frequencies associated one or more of the 3GPP LTE Specifications and/or IEEE 902.16 Standards for WMANs, and/or other broadband wireless networks, cited herein, although the embodiments are not limited in this respect.

Embodiments of device 900 may be implemented using single input single output (SISO) architectures. However, certain implementations may include multiple antennas (e.g., antennas 918) for transmission and/or reception using adaptive antenna techniques for beamforming or spatial division multiple access (SDMA) and/or using MIMO communication techniques.

The components and features of device 900 may be implemented using any combination of discrete circuitry, application specific integrated circuits (ASICs), logic gates and/or single chip architectures. Further, the features of device 900 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary device 900 shown in the block diagram of FIG. 9 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

A computer-implemented method may comprise receiving a control activation for an image inclusion control on a client device; instantiating a hybrid image inclusion interface, the hybrid image inclusion interface comprising at least an image capture interface portion and an image repository interface portion; receiving an interface activation for one of the image capture interface portion and the image repository interface portion; transitioning the image capture interface portion to a full-screen image capture interface where the interface activation is for the image capture interface portion; and transitioning the image repository interface portion to an expanded image repository interface where the interface activation is for the image repository interface portion

A computer-implemented method may further comprise the full-screen image capture interface comprising an image repository expansion control for the image repository interface portion.

A computer-implemented method may further comprise the expanded image repository interface comprising an image capture expansion control for the image capture interface portion.

A computer-implemented method may further comprise the image repository interface portion comprising at least a display of a camera roll for the client device.

A computer-implemented method may further comprise the image repository interface portion comprising at least a display of an image repository for a network image repository service.

A computer-implemented method may further comprise retrieving one or more images of the image repository from the network image repository service via a network interface controller communicatively connected to a network; and displaying the one or more images in the image repository interface portion as the display of the image repository.

A computer-implemented method may further comprise the image repository interface portion comprising at least a display of a plurality of image repositories for a plurality of network image repository services, further comprising: retrieving a plurality of images of the plurality of image repositories from the plurality of network image repository services via a network interface controller communicatively connected to a network; generating a de-duplicated plurality of images from the received plurality of images, wherein the de-duplicated plurality of images excludes duplicated instances of duplicated images in the received plurality of images; and displaying the de-duplicated plurality of images in the image repository interface portion as the display of the plurality of image repositories.

A computer-implemented method may further comprise wherein generating the de-duplicated plurality of images from the received plurality of images comprises selecting one or more higher-quality versions of the duplicated instances of the duplicated images.

A computer-implemented method may further comprise the image capture interface portion comprising at least an image capture control and a live capture preview.

A computer-implemented method may further comprise the interface activation for the image capture interface portion comprising an image capture control activation for the image capture control.

A computer-implemented method may further comprise initiating a still image capture in response to the image capture control activation for the image capture control comprising a press of the image capture control.

A computer-implemented method may further comprise initiating a video image capture in response to the image capture control activation for the image capture control comprising a hold of the image capture control.

A computer-implemented method may further comprise cancelling the video image capture in response to an image capture control deactivation for the image capture control, wherein the image capture control deactivation corresponds to a screen-drag-off gesture on a touchscreen display for the client device.

A computer-implemented method may further comprise uploading a captured image to an image repository for a network image repository service.

A computer-implemented method may further comprise the image inclusion control received in a message composition interface for a messaging client on the client device, further comprising: receiving an image from one of the full-screen image capture interface or the expanded image repository interface; generating an outgoing message, the outgoing message comprising the image; and transmitting the outgoing message to a messaging service via a network interface controller communicatively connected to a network.

An apparatus may comprise a processor circuit on a client device; an image capture device on the client device; a user interface component operative on the processor circuit to receive a control activation for an image inclusion control on the client device; instantiate a hybrid image inclusion interface, the hybrid image inclusion interface comprising at least an image capture interface portion and an image repository interface portion, wherein the image capture interface portion displays a live capture preview for the image capture device; receive an interface activation for one of the image capture interface portion and the image repository interface portion; transition the image capture interface portion to a full-screen image capture interface where the interface activation is for the image capture interface portion; and transition the image repository interface portion to an expanded image repository interface where the interface activation is for the image repository interface portion. The apparatus may be operative to implement any of the computer-implemented methods described herein.

At least one computer-readable storage medium may comprise instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. A computer-implemented method, comprising:
receiving a control activation for an image inclusion control on a client device;
instantiating a hybrid image inclusion interface, the hybrid image inclusion interface comprising at least an image capture interface portion and an image repository interface portion;
receiving an interface activation for one of the image capture interface portion and the image repository interface portion;
transitioning the image capture interface portion to a full-screen image capture interface where the interface activation is for the image capture interface portion; and
transitioning the image repository interface portion to an expanded image repository interface where the interface activation is for the image repository interface portion.

2. The method of claim 1, the image repository interface portion comprising at least a display of a camera roll for the client device.

3. The method of claim 1, the image repository interface portion comprising at least a display of an image repository for a network image repository service, further comprising:
retrieving one or more images of the image repository from the network image repository service via a network interface controller communicatively connected to a network; and
displaying the one or more images in the image repository interface portion as the display of the image repository.

4. The method of claim 1, the image repository interface portion comprising at least a display of a plurality of image repositories for a plurality of network image repository services, further comprising:
retrieving a plurality of images of the plurality of image repositories from the plurality of network image repository services via a network interface controller communicatively connected to a network;
generating a de-duplicated plurality of images from the received plurality of images, wherein the de-duplicated plurality of images excludes duplicated instances of duplicated images in the received plurality of images; and
displaying the de-duplicated plurality of images in the image repository interface portion as the display of the plurality of image repositories.

5. The method of claim 4, wherein generating the de-duplicated plurality of images from the received plurality of images comprises selecting one or more higher-quality versions of the duplicated instances of the duplicated images.

6. The method of claim 1, the image capture interface portion comprising at least an image capture control and a live capture preview.

7. The method of claim 6, the interface activation for the image capture interface portion comprising an image capture control activation for the image capture control.

8. The method of claim 1, the image inclusion control received in a message composition interface for a messaging client on the client device, further comprising:
receiving an image from one of the full-screen image capture interface or the expanded image repository interface;
generating an outgoing message, the outgoing message comprising the image; and
transmitting the outgoing message to a messaging service via a network interface controller communicatively connected to a network.

9. An apparatus, comprising:
a processor circuit on a client device;
an image capture device on the client device;
a user interface component operative on the processor circuit to receive a control activation for an image inclusion control on the client device; instantiate a hybrid image inclusion interface, the hybrid image inclusion interface comprising at least an image capture interface portion and an image repository interface portion, the image capture interface portion displaying a live capture preview for the image capture device, the image repository interface portion comprising at least a display of a camera roll for the client device; receive an interface activation for one of the image capture interface portion and the image repository interface portion; transition the image capture interface portion to a full-screen image capture interface where the interface activation is for the image capture interface portion; and transition the image repository interface portion to an expanded image repository interface where the interface activation is for the image repository interface portion.

10. The apparatus of claim 9, the image repository interface portion comprising at least a display of an image repository for a network image repository service, further comprising:
the user interface component operative to retrieve one or more images of the image repository from the network image repository service via a network interface controller communicatively connected to a network; and display the one or more images in the image repository interface portion as the display of the image repository.

11. The apparatus of claim 9, the image repository interface portion comprising at least a display of a plurality of image repositories for a plurality of network image repository services, further comprising:
the user interface component operative to retrieve a plurality of images of the plurality of image repositories from the plurality of network image repository services via a network interface controller communicatively connected to a network; generate a de-duplicated plurality of images from the received plurality of images, wherein the de-duplicated plurality of images excludes duplicated instances of duplicated images in the received plurality of images, wherein generating the de-duplicated plurality of images from the received plurality of images comprises selecting one or more higher-quality versions of the duplicated instances of the duplicated images; and display the de-duplicated plurality of images in the image repository interface portion as the display of the plurality of image repositories.

12. The apparatus of claim 9, the image capture interface portion comprising at least an image capture control and a live capture preview.

13. The apparatus of claim 9, the interface activation for the image capture interface portion comprising an image capture control activation for the image capture control.

14. The apparatus of claim 9, the image inclusion control received in a message composition interface for a messaging client on the client device, further comprising:
the user interface component operative to receive an image from one of the full-screen image capture interface or the expanded image repository interface; and
a messaging component operative to generate an outgoing message, the outgoing message comprising the image; and transmit the outgoing message to a messaging service via a network interface controller communicatively connected to a network.

15. At least one computer-readable storage medium comprising instructions that, when executed, cause a system to:
receive a control activation for an image inclusion control on the client device;
instantiate a hybrid image inclusion interface, the hybrid image inclusion interface comprising at least an image capture interface portion and an image repository interface portion, the image repository interface portion comprising at least a display of a camera roll for the client device;
receive an interface activation for one of the image capture interface portion and the image repository interface portion;
transition the image capture interface portion to a full-screen image capture interface where the interface activation is for the image capture interface portion; and
transition the image repository interface portion to an expanded image repository interface where the interface activation is for the image repository interface portion.

16. The computer-readable storage medium of claim 15, the image repository interface portion comprising at least a display of an image repository for a network image repository service, comprising further instructions that, when executed, cause a system to:
retrieve one or more images of the image repository from the network image repository service via a network interface controller communicatively connected to a network; and
display the one or more images in the image repository interface portion as the display of the image repository.

17. The computer-readable storage medium of claim 15, the image repository interface portion comprising at least a display of a plurality of image repositories for a plurality of network image repository services, comprising further instructions that, when executed, cause a system to:
retrieve a plurality of images of the plurality of image repositories from the plurality of network image repository services via a network interface controller communicatively connected to a network;
generate a de-duplicated plurality of images from the received plurality of images, wherein the de-duplicated plurality of images excludes duplicated instances of duplicated images in the received plurality of images, wherein generating the de-duplicated plurality of images from the received plurality of images comprises selecting one or more higher-quality versions of the duplicated instances of the duplicated images; and
display the de-duplicated plurality of images in the image repository interface portion as the display of the plurality of image repositories.

18. The computer-readable storage medium of claim 15, the image capture interface portion comprising at least an image capture control and a live capture preview.

19. The computer-readable storage medium of claim 15, the interface activation for the image capture interface portion comprising an image capture control activation for the image capture control.

20. The computer-readable storage medium of claim 15, the image inclusion control received in a message composition interface for a messaging client on the client device, comprising further instructions that, when executed, cause a system to:
receive an image from one of the full-screen image capture interface or the expanded image repository interface;
generate an outgoing message, the outgoing message comprising the image; and
transmit the outgoing message to a messaging service via a network interface controller communicatively connected to a network.
